(19) United States
(12) Patent Application Publication
(10) Pub. No.: US 2007/0138342 A1
(43) Pub. Date: Jun. 21, 2007

(54) Cargo loading apparatus

(76) Inventors: Christopher Lynas, Bristol (GB); Eike Moeller, Niedersachsen (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/640,002

(22) Filed: Dec. 15, 2006

(30) Foreign Application Priority Data
Dec. 16, 2005 (GB) 0525692.0

(51) Int. Cl. B64C 1/22

(52) U.S. Cl. 244/137.1

(57) ABSTRACT

An aircraft comprises a fuselage, a cargo door and a conveying device. The cargo door is set into one side of the fuselage. The conveyor, for example a belt and roller arrangement, may be integrated with the cargo door, and the cargo door may be moveable, about a hinge located on the lower edge of the door, between a deployed position and a closed position. Whilst the cargo door is in the deployed position; the conveyor may be arranged to convey bulk cargo to the aircraft and part of the conveyor may be located outside the aircraft and below the hinge. A plurality of conveyors may be provided.

### RELATED APPLICATION

The current application claims the benefit of priority to British Patent Application No. 0525692.0 filed on Dec. 16, 2005. Said application is incorporated by reference herein.

### TECHNICAL FIELD

The present invention relates to aircraft, and more specifically to an apparatus for loading cargo onto an aircraft.

### BACKGROUND OF THE INVENTION

Many aircraft are arranged to receive cargo via a dedicated cargo door, or doors, mounted on the side of the fuselage. The cargo doors usually access a cargo hold such as the underfloor (i.e. the space between the floor of the lower-most passenger deck and the underside of the fuselage), where cargo may be stored.

Cargo usually falls into one of two categories, namely bulk cargo or container cargo. Container cargo is typically loaded onto the aircraft using a dedicated vehicle due to the weight and size of the containers and their contents. The dedicated vehicle usually includes conveying means for transporting the container cargo into the aircraft. U.S. Pat. No. 6,616,100 (Sankrithi) describes a short-bodied aircraft with a cargo door including a roller arrangement. The cargo door opens to a horizontal position to assist in translating the container cargo laterally into and out of the aircraft.

Bulk cargo on the other hand generally comprises relatively small and light packages (for example passenger luggage). Although, bulk cargo is often small and light enough to be lifted manually it is nevertheless often loaded using a dedicated belt-loader vehicle because it is unsafe for the bulk cargo to be manually lifted to the height required to clear the sill of the cargo door.

Using a dedicated vehicle presents a number of problems, including: increased servicing costs; risk of delay if the belt-loader is not available or if the vehicle or part of the vehicle is faulty; a relatively slow loading procedure; and a lack of flexibility in removing the cargo of passengers who fail to board the aircraft.

It is desirable to be able to load cargo whilst mitigating, or eliminating at least some of the above-mentioned disadvantages.

### SUMMARY OF THE INVENTION

The present invention provides an aircraft comprising a fuselage, a cargo door and a conveying device, the cargo door being set into one side of the fuselage, the conveying device being integrated with the cargo door, and the cargo door being moveable, about an axis located in the region of the lower edge of the door, between a deployed position and a closed position, wherein whilst the cargo door is in the deployed position; the conveying device is arranged to convey cargo to the aircraft and at least part of the conveying device is located outside the aircraft and below the axis located in the region of the lower edge of the door.

Since the conveying device is integrated with the cargo door, and the cargo door is moveable about an axis at the lower edge (in contrast to many cargo doors, which typically open about an axis near the upper edge of the door), embodiments of the present invention may provide a relatively cheap and simple arrangement for loading cargo into the cargo hold. Embodiments of the present invention may also allow cargo, and more preferably bulk cargo, to be manually loaded onto the aircraft without the cargo having to be manually lifted excessively high. For example the cargo preferably need not be lifted above the height of the cargo door sill (the door sill and the axis in the lower edge of the door are expected usually to be at substantially the same height). The cargo preferably need not be lifted above the average chest height for an adult male. The need for a dedicated loading vehicle may thus be reduced or eliminated.

It will be understood that integrated door and conveyor arrangements include arrangements which are connected together, which move together or which are otherwise associated. It will be understood that although the conveying device is integrated with the cargo door, it need not necessarily be fixedly and/or permanently attached thereto. For example, the conveying device may be attached to the fuselage but arranged to move in association with the cargo door (for example via a biased link mechanism).

The axis in the region of the lower edge of the door may be defined by a hinge. The axis may be defined as the axis about which the door notionally rotates when moved between the closed and deployed positions. The axis may be located outside the cargo door.

Whilst it is known to position standard cargo doors on the side of an aircraft, the doors typically either rotate about an axis on the upper edge of the door, or only deploy to a horizontal position. Embodiments of the present invention may ameliorate problems associated with these arrangements. Having a cargo door mounted in the side of the fuselage (in contrast to being mounted in one end of the fuselage) is advantageous, since, for example, it does not necessarily prohibit the provision of more cargo doors on the side(s) of the aircraft.

The cargo hold may be the underfloor. The cargo hold may be all, or part of, the main deck or decks.

At least one part of the conveying device may be mounted on the cargo door. At least one part of the conveying device may be mounted on the aircraft fuselage structure. Alternatively the conveying device may be entirely mounted on the cargo door.

The conveying device may be fixedly mounted, but need not necessarily be. For example, the conveyor may be slideably mounted, for example in a groove. The location of the conveying device may be arranged to move relative to the cargo door when the cargo door is moved between the deployed position and the closed position.

Whilst the cargo door is in the deployed position, at least part of the conveying device may be at a height at which bulk cargo may safely be manually placed. Whilst the cargo door is in the deployed position, at least part of the conveying device may be below the average chest height of an adult male. Whilst the cargo door is in the deployed position, at least part of the conveying device may be less than 2 m above the ground, and more preferably may be less than 1 above the ground.

Whilst the cargo door is in the deployed position, at least part of the conveying device may be at a height at which it will not be damaged by impact with the ground. Such impact may be caused by movement of the aircraft and/or the cargo door, and more particularly vertical movement caused during loading of the aircraft. Whilst the cargo door is in the deployed position, the conveying device may be more than 0.15 m above the ground and more preferably more than 0.3 m above the ground.

It will be appreciated that embodiments of the present invention may be of especial benefit when combined in an aircraft in which the cargo door is relatively high. The axis in the lower edge of the door may be more than 1.5 m, more than 2 m, or even more than 3 m, above the ground when the aircraft is on a runway.

The conveying device may comprise a proximal end and a distal end wherein, whilst the cargo door is in the deployed position, the proximal end is located in the aircraft and the distal end is located outside the aircraft and below the axis. The cargo may therefore be conveniently placed on or near the distal end of the conveying device (which is preferably in an easily accessible location) and thereby loaded onto the aircraft.

When the cargo door is in the closed position the conveying device may be stowed inside the aircraft. More preferably the conveying device may be stowed against the cargo door. Preferably, the conveying device does not substantially adversely impact on the available storage space in the cargo hold.

The cargo door, at least in the deployed position, may be arranged to support the conveying device. Preferably, no additional supports are required for the conveying device, thereby maintaining a relatively low weight penalty. Typically the cargo door need not be significantly reinforced (in comparison to a conventional cargo door) to support the conveyor because it is already of sufficient strength to withstand the pressure loading during flight. The cargo door may be locally reinforced, for example to accommodate point loads caused by the conveying device. Such reinforcement may confer relatively little weight penalty.

The conveying device may comprise a continuously revolveable cargo support, such as a belt or series of plates. The conveying device may be in the form of a belt and roller arrangement. The conveying device may comprise a rack of a plurality of parallel-mounted rollers.

The conveying device may be suitable for conveying into the aircraft, cargo of up to 200 kg, more preferably cargo of up to 500 kg, yet more preferably cargo of up to 1000 kg. The conveying device may be suitable for conveying as much averagely sized and weighted cargo as will fit on the device, preferably with an additional safety margin. The conveying device may be suitable for conveying both bulk cargo and container cargo. The conveying device may be suitable for conveying bulk cargo only. The conveying device may be suitable for conveying container cargo only.

The conveying device need not necessarily be powered, and may for example simply lower the sliding friction of the cargo. This could be achieved with, for example, a plurality of parallel rollers. Such an arrangement may be beneficial in, for example, loading container cargo from a vehicle and situations in which the angle of the conveying device when the door is in the deployed position is low and/or in which the height to which the cargo must be loaded is relatively low.

The conveying device may be powered. The conveying device may be powered from an external source. The conveying device may be powered from the aircraft auxiliary power unit (APU). The conveying device may be powered from the aircraft engines. The conveying device may be connected to an external source. The conveying device may be connected to the aircraft power systems.

The conveying device may be controlled via a control panel. The control panel may control, for example, the speed and direction at which the conveying device conveys cargo. Alternatively or additionally the control panel may control whether the conveying device is on or off. The control panel may comprise a switch or plurality of switches for controlling the conveying device. The aircraft may comprise a plurality of control panels. A control panel may be located on the conveying device, on the outside of the aircraft fuselage and/or on the inside of the aircraft fuselage. At least one control panel may be easily accessible by ground staff.

Embodiments of the present invention may be arranged to convey cargo directly into the cargo hold of the aircraft. In an embodiment of the invention, cargo may be arranged into the cargo hold of the aircraft without further manual intervention after the cargo has been placed on the conveying device. The aircraft may comprise a cargo management system in the cargo hold. The cargo management system may, for example, be a fully automated belt and roller arrangement.

The conveying device may be associated, connected or integrated with the cargo management system in the cargo hold. The conveying device may co-operate with the cargo management system, such that cargo is transferred directly from the conveying device to the cargo management system. The conveying device may comprise a roller, at least part of which overhangs or borders the cargo hold, or more preferably overhangs or borders the cargo management system located therein. The cargo will then drop, slide or otherwise be moved into the cargo hold without the need for manual intervention. The roller may be powered. The roller may form part of the belt and roller arrangement. The roller may be fixedly mounted on the fuselage. The located of the roller may move in relation to the fuselage when the cargo door is moved between the closed and deployed position. The roller, may, for example, be mounted on a link mechanism. The roller may for example, be mounted on a crank and slider mechanism.

The length of a single conveying device, and/or the angle to which it may be deployed, will in some embodiments be limited to some extent by the size and arrangement of the cargo door. The height to which cargo must be lifted may thus be dictated by the length and angle of the cargo door in the deployed position, and the height may be too high for manual loading. To mitigate this problem, the aircraft may comprise a plurality of conveying devices that are arranged to co-operate when the cargo door is in the deployed position. The aircraft may comprise a multiplicity of conveying devices that are arranged to co-operate when the cargo door is in the deployed position. The conveying devices may co-operate such that at least one point on the conveying devices is at a height suitable for manual loading whilst the cargo door is in the deployed position.

The conveying devices may be arranged such that cargo is directly conveyed from one device to another device. Two or more of the conveyer devices may be integrated with the cargo door. The conveying devices may be compactly arranged when the cargo door is in the closed position. For example the plurality of conveying devices may be arranged to be folded together when the door is in the closed position, and unfolded when in the deployed position. The conveying devices may be arranged substantially in-line with one another when the cargo door is in the deployed position.

The conveying devices need not necessarily be the same type of device. For example, a first conveying device may be in the form of a powered belt and roller arrangement and a second conveying device may be in the form or a parallel roller arrangement.

The aircraft may comprise an actuator, the actuator being arranged to effect relative movement of the conveying devices when the cargo door is moved between the closed position and the deployed position. The actuator may be a motor. The actuator may, for example, be a biased link mechanism.

Alternatively or additionally the aircraft may comprise an extendable conveying device. The conveying device may be in an unextended state whilst the cargo door is in the closed position and an extended state whilst the cargo door is in the deployed position. At least one point on the extended conveying device is preferably at a height suitable for manual loading when the cargo door is in the deployed position.

According to another aspect of the present invention, there is provided a cargo door and a conveying device, the cargo door and the conveying device being integrated and suitable for use on the aircraft of the present invention.

According to yet anther aspect of the present invention, there is provided a method of loading cargo onto an aircraft according to the present invention, the method comprising the steps of: opening the cargo door from a closed position to an deployed position, and placing cargo on the conveying device to move the cargo to, and preferably directly into, the aircraft.

It will be appreciated that aspects of the present invention described in relation to the method of the present invention are equally applicable to the apparatus of the present invention and vice versa. It will also be understood that reference herein to aspects of a single conveyor device may equally apply to one or more conveying devices in the event that there is more than one, and vice versa.

### DESCRIPTION OF THE DRAWINGS

Various embodiments of the invention will now be described, by way of example only, with reference to the accompanying schematic drawings of which:

FIGS. 1a to 1c are cross-sectional views of the fuselage of an aircraft according to a first embodiment of the invention;

FIGS. 2a to 2c are cross-sectional views of the fuselage of an aircraft according to a second embodiment of the invention;

FIGS. 3a to 3c are cross-sectional views of the fuselage of an aircraft according to a third embodiment of the invention;

FIGS. 4a to 4c are cross-sectional views of the fuselage of an aircraft according to a fourth embodiment of the invention;

FIG. 5 is a cross-sectional view of the fuselage of an aircraft according to a fifth embodiment of the invention.

### DETAILED DESCRIPTION

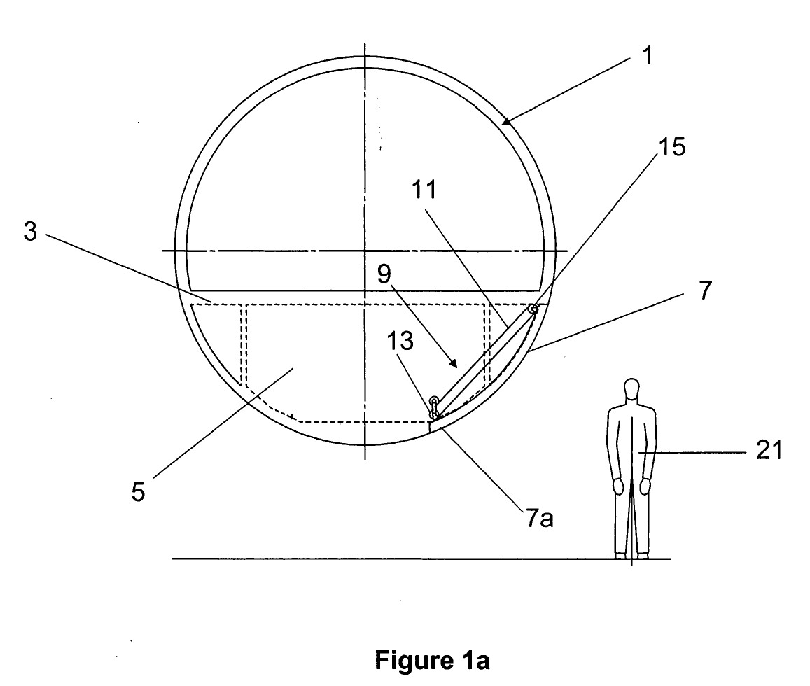

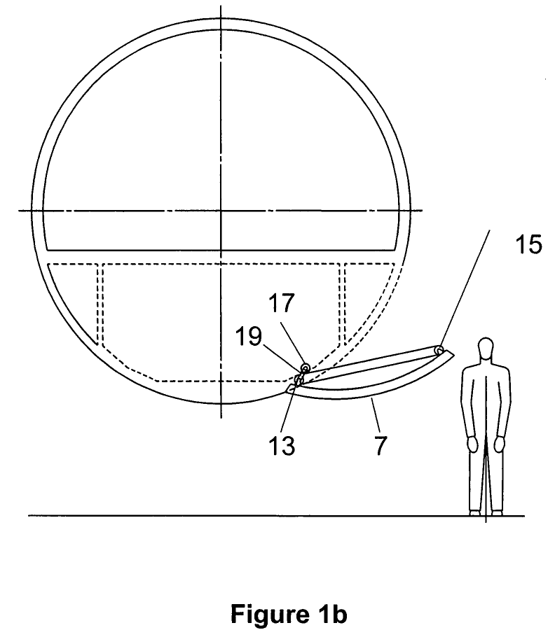

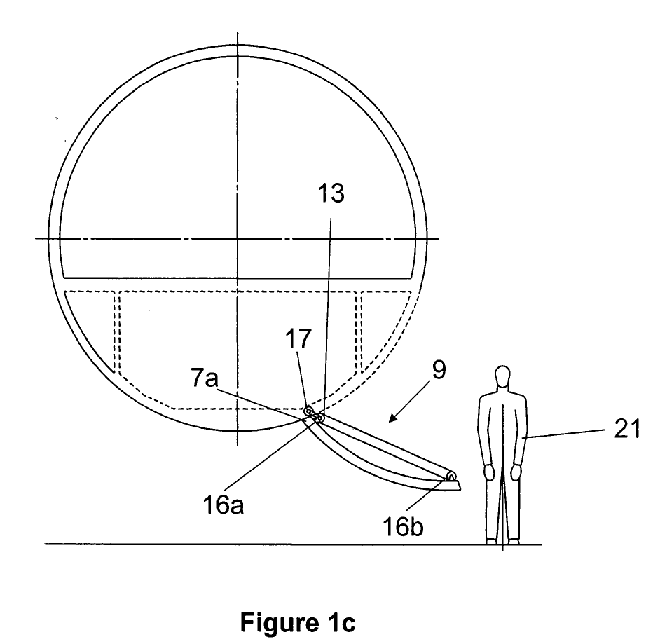

FIGS. 1a to 1c show a cross-section of a fuselage 1 of a commercial passenger aircraft. The fuselage 1 contains a passenger deck floor 3, under which there is an underfloor area 5 bounded by the floor 3 above and the lower part of the fuselage 1 below. The underfloor acts as the cargo hold for the aircraft.

A cargo door 7 is set into the side of the fuselage 1. The door 7 is hinged about an axis located at its lower end 7a and is moveable between a closed position (shown in FIG. 1a) and deployed position (shown in FIG. 1c).

Mounted on the inside of the cargo door 7 is a conveying device 9 suitable for carrying cargo. The conveying device 9 comprises an endless belt 11 (arranged to travel around two end rollers 13 and 15) and a supplementary roller 17 mounted on a pivotable link 19. The two end rollers 13, 15, and the pivotable link 19, are mounted on supports 16a, 16b attached to the cargo door 7. The conveying device 9 is therefore integral to the cargo door and is in substantially the same position relative to the door when the door is in the deployed and the closed position. Furthermore, the cargo door substantially supports the conveying device 9, and any cargo it may carry.

The cargo door 7 and integral conveying device 9 of the first embodiment of the invention allows cargo to be loaded onto the aircraft without the need for certain additional vehicles and/or loading systems, as is described below:

Referring to FIG. 1a, when the cargo door 7 is in the closed position the conveying device 9 is conveniently stowed occupying a relatively small space. This is particularly advantageous because the provision of the conveying device thereby does not significantly impact on the available storage volume in the underfloor 5.

FIG. 1b shows the cargo door during movement between the deployed and the closed position. The movement between the two positions is effected by an electric motor (not shown) which is powered from the aircraft auxiliary power unit (APU).

The deployed position (shown in FIG. 1c) is defined by the rotation limit of the hinge (not shown) on the lower end 7a of the door 7. When the door 7 is in the deployed position, the conveying device 9 is operable. The conveying device 9 is powered by the aircraft auxiliary power unit (APU), such that it can, during use, transport up to 20 pieces of 25 kg cargo at any one time. The conveying device 9 is controlled via switches located on both the aircraft fuselage 1 and near the roller 15 close to the top of the door. The switches (not shown) control both the direction and the speed of rotation of the rollers 13, 15. It will be understood that the speed and direction of the belt 11, which may be used to carry cargo, can therefore be controlled. The conveying device can therefore be used to carry cargo towards, or away from, the aircraft at the control of airport ground staff.

It will be understood that the conveying device and the cargo door are subjected to relatively large loads when cargo is being loaded to or from the aircraft. However, cargo door 7 requires little support over and above that of a conventional cargo door. That is because the door is designed to cope with the considerable pressure loads that occur during flight and is already of sufficient strength. The hinge is reinforced.

In the deployed position, the conveying device 9 is positioned at an angle below the horizontal and to one side of the fuselage. The belt is therefore below the level of the lower end 7a of the door 7 and the axis about which the door is moveable. Thus a person 21 (for example a member of the aircraft ground staff) can load cargo into the aircraft without having to lift the cargo to a height above the door sill (at which the lower end 7a of the door is located). It will be understood that such an arrangement provides a number of benefits, for example, it is safer and easier than attempting to manually lift cargo over the sill, and a belt loader vehicle is not required.

The conveying device 9 is also arranged to transport cargo into the underfloor with little or no intervention from the operator. Link mechanism 19 of the supplementary roller 17 is arranged such that, when the door is in the deployed position, the supplementary roller 17 is above the end roller 13 (see FIG. 1c) and overhangs into the underfloor 5. The supplementary roller 17 is powered by an electric motor (not shown) connected to the aircraft APU. The supplementary roller thereby ensures a smooth transition of cargo from the top of the belt to the cargo management system (not shown) in the underfloor and prevents cargo becoming lodged at the top of the conveyor means.

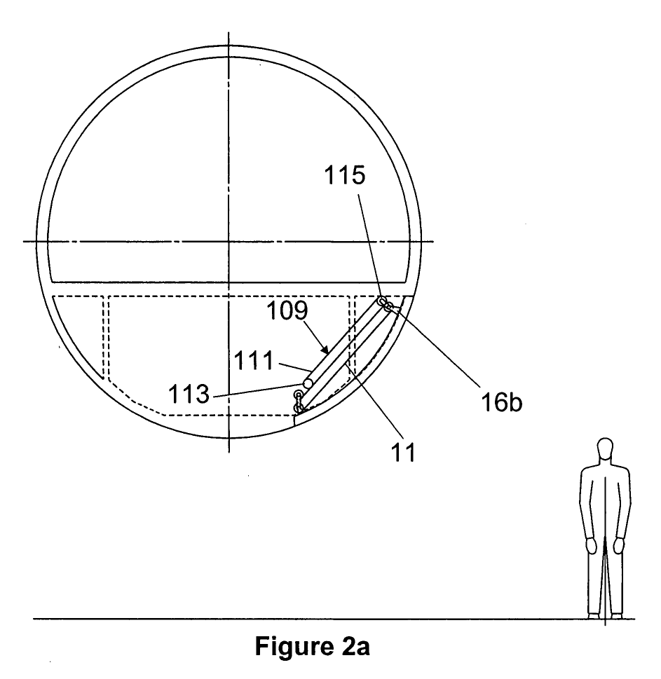

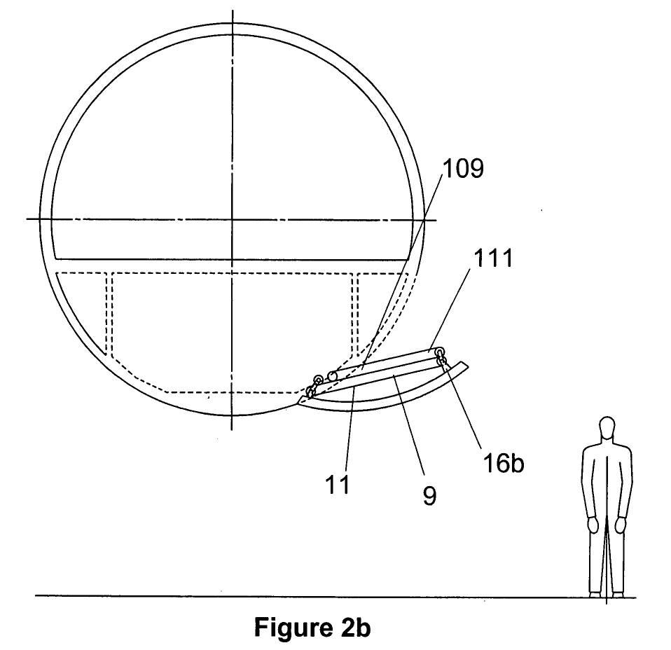

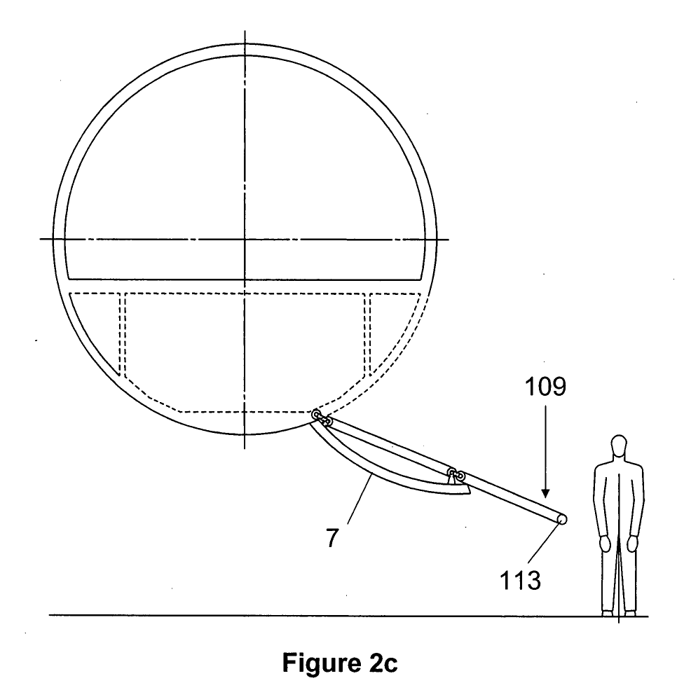

FIGS. 2a to 2c show a second embodiment of the invention. The second embodiment is broadly similar to the first embodiment except for the provision of an additional belt and roller mechanism 109. The conveying device comprises a second belt 111 and two more rollers 113, 115. The additional belt and roller mechanism is arranged to fold against the main belt 11 when the cargo door is closed (see FIG. 2a), but to adopt an unfolded position when the cargo door is in the deployed position (see FIG. 2c). The additional belt and roller mechanism is moved to the unfolded position by an actuator (not shown) in the support 16b.

It will be understood that the provision of the conveying device in the second embodiment of the invention is particularly advantageous when the length of the first belt and/or the angle to which the conveying device can operate, is insufficient to lower the height to which cargo must be lifted, to a suitable level. In the second embodiment of the invention, one end of the second belt 111 is less than 1 m above the ground and cargo is therefore easily loadable onto this part of the belt 111.

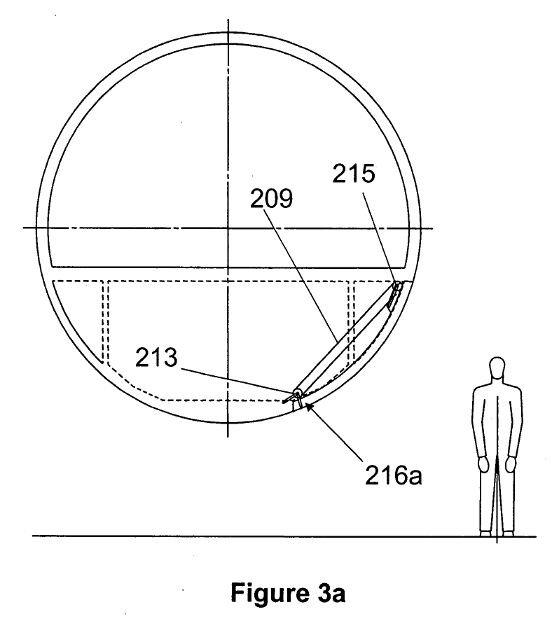

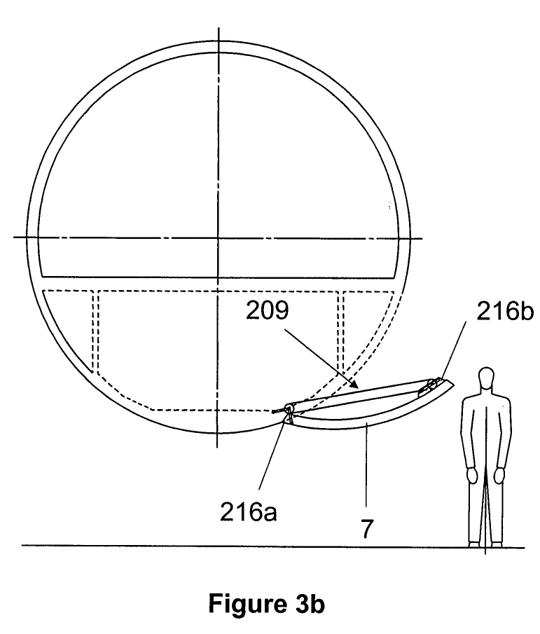

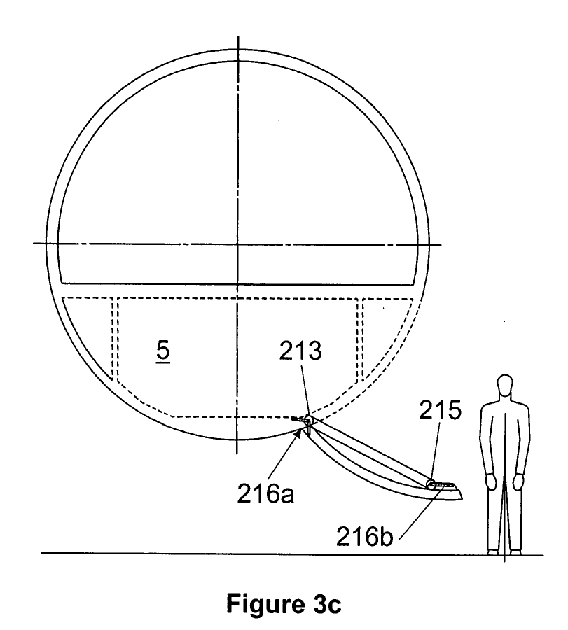

A third embodiment is also similar to the first embodiment except for the differences described below. As shown in FIGS. 3a to 3c, one of the conveying device rollers 213, is not mounted on rigid mountings, but rather on a four bar link mechanism 216a. The other roller 215 is mounted in a groove 216b. The rollers are therefore arranged to move relative to the cargo door 7 when the door moves between the deployed and the closed positions. In comparison with the first embodiment, the top of the conveying device 209 in the third embodiment is thus higher and closer to the underfloor 5, than the corresponding roller 13 in the first embodiment. Such an arrangement is particularly advantageous because it better delivers the cargo to the underfloor 5 and the cargo management system located therein (not shown).

In this example, the cargo management system comprises a plurality of belts and rollers. The top of the conveying device 209, whilst the cargo door is in the deployed position, co-operates with a belt and roller arrangement of the cargo management system. Cargo is therefore smoothly transferred from the conveying device to the cargo management system and the underfloor.

In this example, the cargo door 7 is not powered and instead is opened and closed manually. In addition, the deployed position is defined not by the movement of the hinge, but rather a pair of stays (not shown) mounted in the aircraft structure.

In this example, the conveying device is electrically powered from an external source available on the ground. The aircraft APU does not therefore need to be running for the cargo to be loaded.

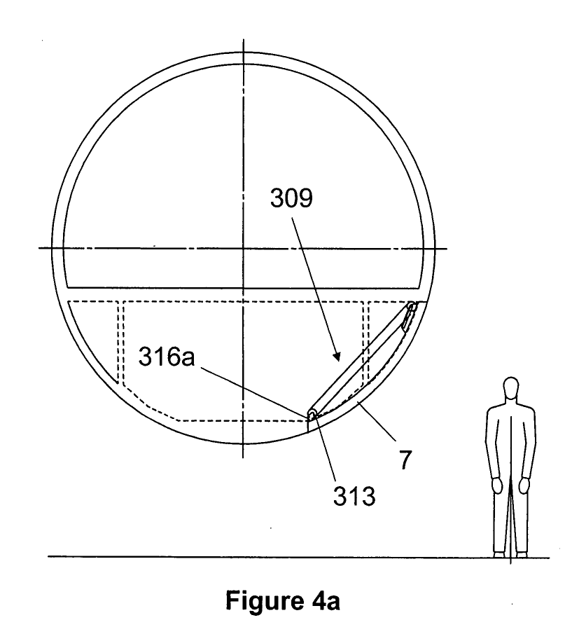

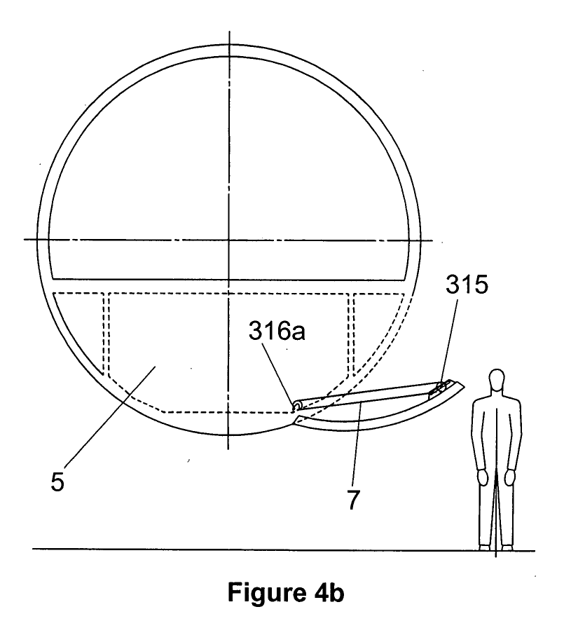

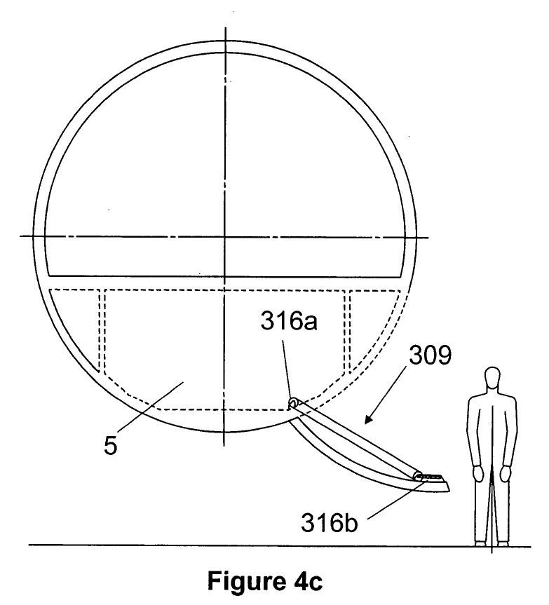

According to a fourth embodiment (shown in FIGS. 4a to 4c) an end roller 313 of the conveying device 309 is mounted on a support 316a on the aircraft fuselage 1, at a location just above the door sill. The other end roller 315 is mounted in a groove arrangement 316b on the top of the cargo door 7, such that the conveying device 309 follows the movement of the door 7 between the deployed and the closed position. Having a roller fixed to the fuselage above the door sill, allows cargo to be efficiently transported into the underfloor 5 without the need for additional rollers or link mechanisms as described above in relation to other embodiments of the invention.

It will be understood that whilst part of the conveying device 309 is attached to the fuselage, the conveying device is nevertheless integrated with the cargo door 7.

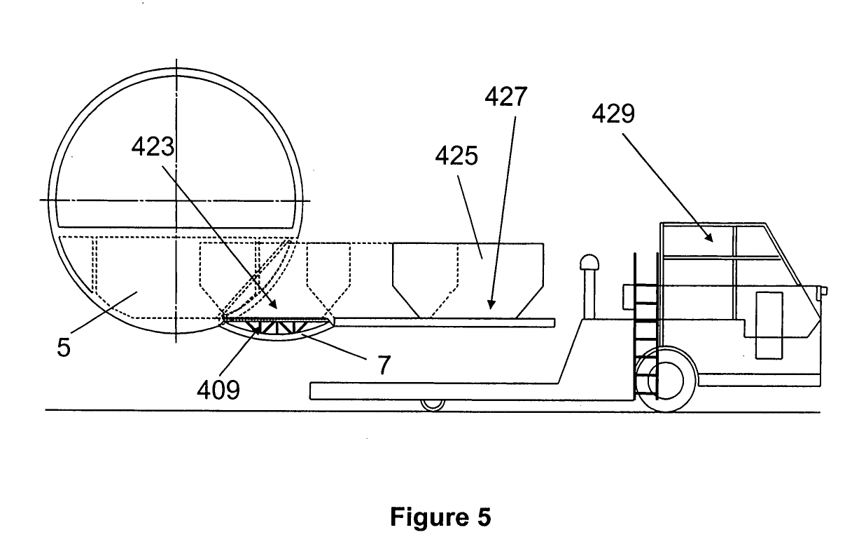

FIG. 5 shows a fifth embodiment of the present invention. The conveying device 409 comprises a multiplicity of rotatable cylinders 423 mounted parallel to one another. According to the fifth embodiment, the conveying device is substantially horizontal when the cargo door is in the deployed position. The conveying device 409 is also not powered in this example allowing the cargo to be loaded whilst the aircraft APU is not running.

Such an arrangement is particularly beneficial for loading container cargo 425 from a container loading platform 427 because the containers may be slid from the platform 427 into the underfloor 5 with relative ease. The fifth embodiment may also mitigate the need for a conveying device on the vehicle 429 that is designed to reach into the cargo hold 5.

A second, or further, conveyor mechanism may be provided in any of the above-mentioned embodiments. The conveying device need not be a belt and roller arrangement. The aircraft may comprise a plurality of cargo doors in accordance with the invention.

Whilst the present invention has been described and illustrated with reference to particular embodiments, it will be appreciated by those of ordinary skill in the art that the invention lends itself to many different variations not specifically illustrated herein. Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims.

1. An aircraft comprising a fuselage, a cargo door and a conveying device, the cargo door being set into one side of the fuselage, the conveying device being integrated with the cargo door, and the cargo door being moveable, about an axis located in the region of the lower edge of the door, between a deployed position and a closed position, wherein
whilst the cargo door is in the deployed position, the conveying device is arranged to convey cargo to the aircraft and at least part of the conveying device is located outside the aircraft and below the axis located in the region of the lower edge of the door.

2. An aircraft according to claim 1, wherein at least one part of the conveying device is mounted on the cargo door.

3. An aircraft according to claim 1, wherein the location of the conveying device is arranged to move relative to the cargo door, when the cargo door is moved between the deployed position and the closed position.

4. An aircraft according to claim 1, wherein whilst the cargo door is in the deployed position, at least part of the conveying device is at a height suitable for manual loading.

5. An aircraft according to claim 4, wherein whilst the cargo door is in the deployed position, at least part of the conveying device is less than 1 m above the ground.

6. An aircraft according to claim 1, wherein when the cargo door is in the closed position the conveying device is stowed inside the aircraft and against the cargo door.

7. An aircraft according to claim 1, wherein the cargo door, whilst in the deployed position, is arranged to support the conveying device.

8. An aircraft according to claim 1, wherein the conveying device is in the form of a belt and roller arrangement.

9. An aircraft according to claim 1, comprising a plurality of conveying devices arranged to co-operate when the cargo door is in the deployed position, such that at least one point on the conveying devices is at a height suitable for manual loading when the cargo door is in the deployed position.

10. An aircraft according to claim 1, comprising a multiplicity of conveying devices arranged to co-operate when the cargo door is in the deployed position, such that at least one point on the conveying devices is at a height suitable for manual loading when the cargo door is in the deployed position.

11. An aircraft according to claim 1, wherein the conveying device is powered.

12. An aircraft according to claim 11, wherein the conveying device is powered from an aircraft auxiliary power unit (APU).

13. An aircraft according to claim 1, wherein the conveying device is arranged to convey cargo directly into the cargo hold of the aircraft.

14. An aircraft according to claim 13, wherein the cargo is conveyed into the cargo hold without further manual intervention after the cargo has been placed on the conveying device.

15. A cargo door and a conveying device, the cargo door and the conveying device being integrated and suitable for use on the aircraft of claim 1.

16. A method of loading cargo onto an aircraft, the method comprising the steps of:
providing an aircraft comprising a fuselage, a cargo door and a conveying device, the cargo door being set into one side of the fuselage, the conveying device being integrated with the cargo door,
opening the cargo door from a closed position to a deployed position by rotating the cargo door about an axis located in the region of the lower edge of the door, at least part of the conveying device being located outside the aircraft and below said axis,
and placing cargo on the conveying device to move the cargo into the aircraft.

17. An aircraft comprising a fuselage, a cargo door and a plurality of conveying devices, the cargo door being set into one side of the fuselage, the plurality of conveying devices being integrated with the cargo door, the cargo door being moveable, about an axis located in the region of the lower edge of the door, between a deployed position and a closed position,
and whilst the cargo door is in the deployed position, the plurality of conveying devices being arranged to co-operate, such that at least one point on the conveying devices is located outside the aircraft, below the axis located in the region of the lower edge of the door, and at a height suitable for manual loading of bulk cargo thereon.

18. A method of loading cargo onto an aircraft, the method comprising the steps of:
providing an aircraft comprising a fuselage, a door and a plurality of conveying devices, the door being set into one side of the fuselage, the plurality of conveying devices being integrated with the door,
moving the door from a closed position to a deployed position to expose an opening in the fuselage,
manually loading, from the ground, an item of bulk cargo onto at least one of said conveying devices,
the item of cargo, immediately after being so loaded, being positioned outside of the aircraft and vertically beneath said opening, and
conveying the bulk cargo by means of said plurality of conveying devices, via the opening, to inside the fuselage.
